(19) United States
(12) Patent Application Publication
(10) Pub. No.: US 2009/0007718 A1
(43) Pub. Date: Jan. 8, 2009

(54) Multiple Pin Locking Device of an Adjustment Device of a Motor Vehicle Seat

(76) Inventors: WILFRIED BENEKER, LEICHLINGEN (DE); AXEL SPECK, HAAN-GRUITEN (DE)

Correspondence Address: MCCARTER & ENGLISH LLP;CITYPLACE I, 185 ASYLUM STREET, HARTFORD, CT, 06103, US

(21) Appl. No.: 12/166,917

(22) Filed: Jul. 2, 2008

(30) Foreign Application Priority Data
Jul. 4, 2007 (DE) 10 2007 031 191.7

(51) Int. Cl. G05G 5/06

(52) U.S. Cl. 74/535

(57) ABSTRACT

The pawl locking device of an adjustment device of a motor vehicle seat serves for adjusting two parts of said motor vehicle seat in one direction of adjustment. It has at least three stopper parts that are elastically biased independent of each other in a locking position by one stopper spring each. Said stopper parts each comprise one stopper tooth, one actuation end and one bearing hole. The longitudinal adjustment device further has a bearing shaft that extends in the direction of adjustment and through the bearing hole of said stopper parts.

### CROSS-REFERENCE TO RELATED APPLICATIONS

This application claims priority to German Application No. DE 10 2007 031 191.7, filed Jul. 4, 2007, which is hereby incorporated by reference in its entirety as part of the present disclosure.

### BACKGROUND OF THE INVENTION

The invention relates to a pawl locking device of an adjustment device of a motor vehicle seat for adjusting two parts of the motor vehicle seat in an adjustment device, in a lengthwise adjustment device in particular, with stopper parts elastically biased independent of each other in a locking position by one stopper spring each, and with a bearing shaft that extends in the direction of adjustment and carries the bearing parts and also makes it possible for the stopper parts to come free together by pivotal movement.

The document DE 27 29 770 C2 or U.S. Pat. No. 4,189,957 shows in FIG. 1 a pawl locking device for longitudinal adjustment of a motor vehicle seat with two stopper parts biased independent of each other in the locking position, which is the normal one. By a pivotal movement of the bearing shaft, which has not been illustrated in FIG. 1, these stopper parts may be brought into the release position against the action of stopper springs (not shown). The two stopper parts are disposed for pivotal movement about this bearing shaft, the bearing shaft extends parallel to the direction of adjustment. The FIGS. 2 and 3 show another locking device which has no pivotal stopper parts but stopper pins instead, which are displaceable in the longitudinal direction thereof. In this construction, a bearing shaft is not needed; longitudinal guides are utilized instead. The invention is not related to locking device with stopper pins of this type, meaning to multiple pin locking devices.

Presently, catch devices are being developed, which tend to be accommodated within a channel cavity of a rail arrangement. In this sense, it was the multiple pin locking device that has been substantially developed in recent times. Currently, locking devices with stopper pins are usually being substantially utilized in the actual motor vehicles. Multiple-pin locking devices bring the advantage that releasing the discrete stopper pins by pulling may be readily achieved in terms of construction.

### SUMMARY OF THE INVENTION

This is where the invention comes into play. It is its object to develop locking devices with pawls in such a manner that the locking device may be disposed within the channel cavity of the pair of rails of a longitudinal adjustment device, with the least possible component parts, it being anticipated to achieve the same locking as it is currently achieved for example with three to four stopper pins.

This object is solved by the pawl locking device of an adjustment device of a motor vehicle seat for adjusting two parts of the motor vehicle seat in one direction of adjustment, said pawl locking device having at least three stopper parts that are elastically biased in a locking position independent of each other by one stopper spring each. These stopper parts each comprise a stopper tooth, an actuation end and a bearing hole. The longitudinal adjustment device further has a bearing shaft that extends in the direction of adjustment and through the bearing hole of the stopper parts.

This locking device needs very few component parts and may be readily accommodated within a cavity of the two rails of a pair of rails of a longitudinal adjusting device. The top side of the uppermost of the two rails can remain completely free. Currently, this cannot be achieved with a pin locking mechanism. Since an upper flange of the upper rail remains free, it may be utilized for other functions in terms of construction, such as for the superstructure of the seat without having to take into account the locking device. Savings can be made with regard to overall height in particular.

The locking device can be of a very small construction. It may take high locking forces. A disadvantage of the multiple-pin locking devices, which is that stopper pins are ejected upward, out of the locking mechanism, in an impulse-like fashion in the event of a crash, is not to be expected with pawls or can in any case be prevented more easily in terms of construction.

In a preferred embodiment, stopper tooth and actuation end of the stopper part are connected to, and integral with, each other. As a result, every single stopper part can be actuated on purpose. The condition of every single stopper part can be seen from the position of its actuation end. The actuation end protrudes outward from the channel cavity and is immediately available for an actuation unit, namely a release part of an actuation unit. As a result, actuation unit and stopper part are caused to cooperate directly, without intermediate parts. This permits to save component parts; weight and mounting expense are also reduced.

In a preferred embodiment, the stopper part is a flat piece of sheet steel, in particular a stamped sheet steel part. Its main plane preferably lies in a radial plane of the bearing shaft and is accordingly rotated 90° with respect to the stopper part as it is known from FIG. 1 of the document DE 27 29 770 C2. In this arrangement, several stopper parts can be disposed one behind the other in the direction of adjustment and there is space left for other component parts such as stopper springs. The main planes of neighbouring stopper parts preferably lie in planes that extend parallel to each other.

The bearing shaft is connected to one of the two rails, preferably to an upper rail. It is possible to fasten the bearing shaft directly to the rail. In an advantageous developed embodiment, the approach chosen is a different one. The stopper parts, their stopper springs and the bearing shaft are assembled to form a pre-assembled structural unit. A bearing part is provided to make this possible. This bearing part retains the bearing shaft and is itself fixed in the rail. As a result, the mounting expense is reduced.

Preferably, the bearing part has a shear window for each stopper part. The dimensions of the shear window correspond to the cross section of the stopper teeth, which extend through the respective shear windows. In the event of an accident, the stopper tooth is only loaded in the region between a detent ledge and the shear window, hardly any load being exerted onto the bearing shaft itself.

This may be further improved in that the bearing part also provides for passageways for the actuation ends. The passageways are thereby of dimensions adapted to the cross section of the actuation end and to its travel, the actuation ends are permanently located within these passageways. In this way, crash forces are intercepted without the bearing shaft having to be designed for high load. It is possible to configure the bearing shaft to be quite thin, it may for example also be made from an elastic material. It must not be designed to absorb locking forces.

Preferably, the locking device is provided and suited for a locking device for longitudinal adjustment. Such a locking device for longitudinal adjustment possesses two rails, one first rail of which carries or forms a detent ledge. The detent ledge comprises periodically disposed detent windows and detent webs. The stopper teeth engage into the detent windows.

In preferred implementation the stopper part is a two-arm lever. The one lever arm is formed by the actuation end, the other lever arm by the stopper tooth. The two lever arms are preferably inclined at an angle of about 135° to each other, with the bearing shaft being the origin of the angle. Other angles are possible such as an angle of 30 to 180° between the actuation end and the pawl. Preferably, the passageways are located in the second rail, in a profile part of this rail, which extends substantially vertically, meaning that it extends in the x-z plane. In most cases, this region offers more space than above the rail, where the seat is located.

In a preferred implementation, the stopper spring is configured to be a torsion spring and is plugged onto the bearing shaft; it abuts on the associated stopper part and on the associated rail, or rather on the bearing part connected to this second rail.

### BRIEF DESCRIPTION OF THE DRAWINGS

Other features and advantages will become more apparent upon reviewing the appended claims and the following non restrictive description of embodiments of the invention, given by way of example only with reference to the drawing. The invention lies in each and every novel feature or combination of features mentioned in the claims or described herein after. In said drawing:

FIG. 1: shows an end view of a pair of rails with a locking device and an associated actuation unit, viewed in the direction of adjustment; the unlocked condition of the locking device is shown;

FIG. 2: shows an illustration like in FIG. 1, but now in the locked condition;

FIG. 3: shows a sectional view taken along section line III/III in FIG. 2;

FIG. 4: shows a sectional view taken along section line IV/IV in FIG. 2;

FIG. 5: shows a sectional view taken along section line V/V in FIG. 2;

FIG. 6: shows a side view of the device like in FIG. 1, looking into the viewing direction of section III/III, but now no longer in a sectional view;

FIG. 7: shows a side view of the device like in FIG. 2, viewing direction like in section IV/IV, but not as a section;

FIG. 8: shows a top view of the device shown in FIG. 6;

FIG. 9: shows a sectional view taken along section line IX/IX in FIG. 7 and

FIG. 10: shows a perspective illustration of a locking module.

### DETAILED DESCRIPTION OF THE INVENTION

The Figs. show one single exemplary embodiment; other exemplary embodiments are possible and the single exemplary embodiment shown does not exclude any other. In the Figs., the x-y-z coordinate system shows in a known way the orientation when mounted in a motor vehicle.

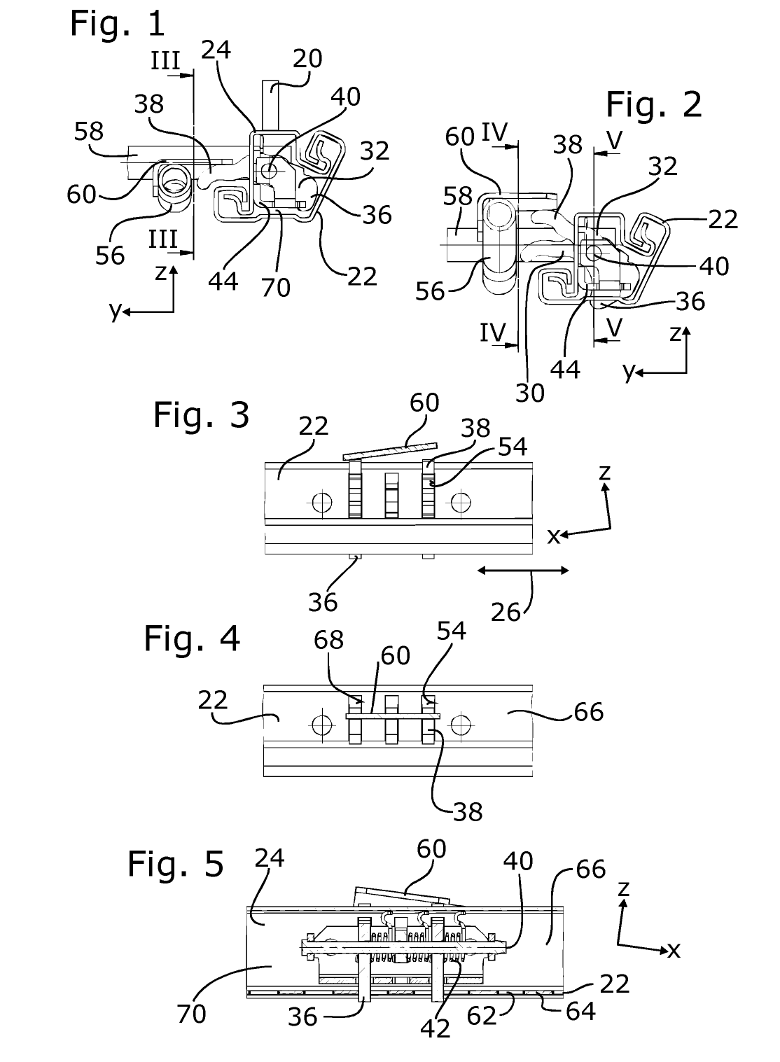

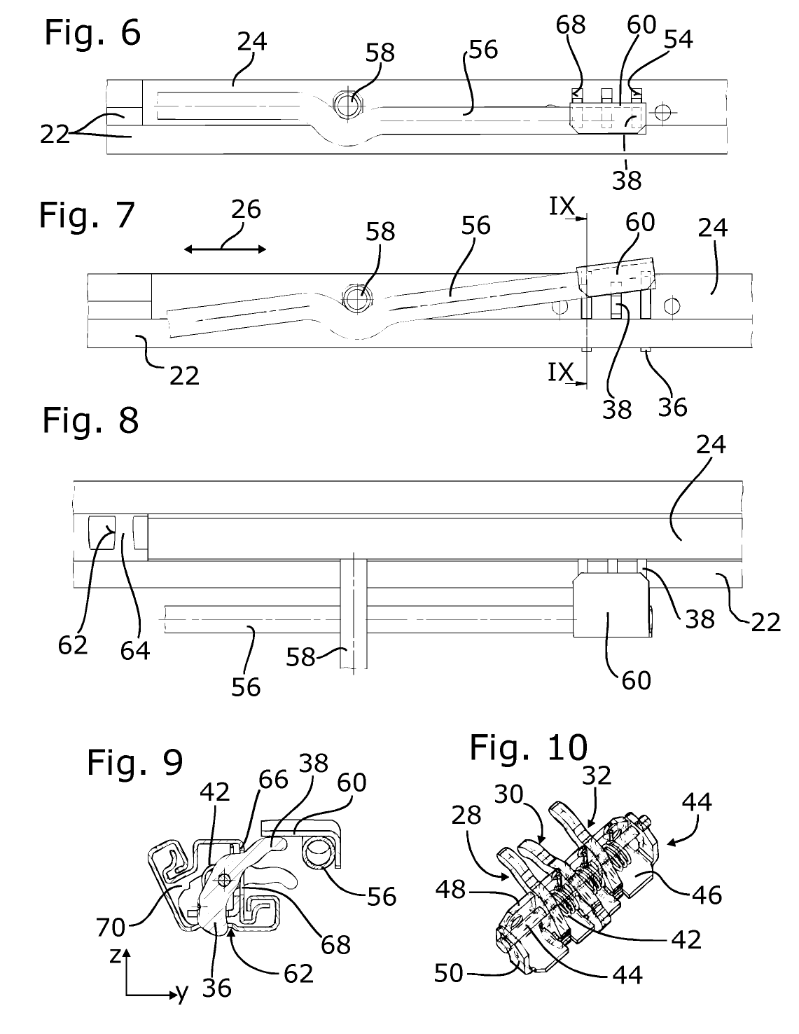

An actually known longitudinal adjustment device of a prior art motor vehicle seat, which is suggested here by only one component part 20, has a first rail 22 and a second rail 24 in engagement with said first rail. Both rails 22, 24 are slidable in one direction of adjustment 26 through guide means that have not been illustrated herein, said direction of adjustment being perpendicular to the plane of the drawing in the FIGS. 1 and 2. The first rail 22 is also referred to as the bottom rail; in the mounted condition, it is connected to an underbody (not shown herein) of a motor vehicle. The second rail 24 is also referred to as the top rail; the superstructure of the motor vehicle seat is in connection therewith. The longitudinal adjustment device has a pawl locking device and an actuation unit associated therewith which has a handle. These parts will be discussed herein after in closer detail.

The pawl locking unit of the exemplary embodiment has three stopper parts 28, 30, 32 that are cut from sheet steel to flat sheet steel parts, here punched sheet steel parts. The three stopper parts 28 through 30 are identically built. Each stopper part has a bearing hole 34 that coincides approximately with the center of gravity, two arms extending from this bearing hole 34. An arm extending substantially downward forms the stopper tooth 36; it is responsible for locking; a laterally extending arm is the actuation end 38 for actuation of the stopper part.

Further, a bearing shaft 40, which is fixed relative to the top rail 24, belongs to the pawl locking device. This bearing shaft 40 extends through the bearing holes 34 of the stopper parts 28-32. The stopper parts 28-32 are not connected to the bearing shaft 40 but are pivotal about an angle of about 30°, more specifically of 15° through 50° relative thereto, the two end positions are shown in the FIGS. 2 and 9.

Further, several stopper springs 42, namely one stopper spring 42 for each stopper part 28-32, belong to the pawl locking device. In the exemplary embodiment shown, they are configured to be torsion springs; they are identically built and are located between the stopper parts 28-32. The stopper parts 28-32 are arranged parallel to each other. In the unlocked position as it is shown in FIG. 1 the three stopper parts 28-32 are aligned so that the rearmost stopper part 32 is visible.

It is possible to provide more than three stopper parts, preferably four stopper parts. It is not envisaged to use less than three stopper parts.

In the preferred configuration, a bearing part 44 belongs, although not necessarily, to the pawl locking device. In the direction of adjustment 26, it is L-shaped in profile and has a lower flange 46 and an upper flange 48. At each of its end regions located in the direction of adjustment 26, there is provided an end flange 50 for retaining and supporting the bearing shaft 40 therein. The bearing shaft 40 extends parallel to the direction of adjustment 26. The bearing part 44 is made from a sheet steel blank and curved. In its lower flange 46, the bearing part 44 has three stopper windows 52 in all. They are all built identically. They are of dimensions adapted to the cross section of the stopper teeth 36. Each of the stopper teeth 36 permanently engages the associated stopper window 52.

In the upper flange 48, a passageway 54 is provided for each stopper part 28-32. This passageway 54 also conforms to the cross section dimensions, in the exemplary embodiment shown, the passageway 54 is open toward the top, toward the free end of the upper flange 48. The actuation ends 38 are permanently located within the passageways 54. For each actuation end 38, there is provided a passageway 54. The passageways 54 are built identically, just like the stopper windows 52.

The pawl locking device described herein can be seen from FIG. 1 0. In the illustration there, the stopper parts 28-32 are shown in various conditions. This corresponds to the condition as it can be seen from the FIGS. 5 and 9, meaning in the mounting condition, and does not correspond to the condition of a free component part that has been removed from the remaining longitudinal adjustment device, because, before or after mounting, all the stopper parts 28-32 shown in FIG. 10 are in the same position, namely in the position in which they lock completely.

FIG. 10 shows that the parts of the pawl locking device that have been discussed herein may be made and mounted as a prefabricated component part and that the module shown in FIG. 10 can be placed into a pair of rails.

For actuating the pawl locking device, an actuation unit is provided in a known way. It has a hand lever 56 that is carried for pivotal movement about a pivot axis 58 that protrudes transversely from the top rail 24 and carries a release part 60 at its rear end (when viewed in the x-direction). It has the shape of a plate and a sufficient length in the x direction to overlap all the actuation ends 38 as this is particularly visible in the FIGS. 3, 4, 7 and 8.

Hand lever devices with dead center springs as they have been known for example from EP 1 048 513 C1 are particularly suited for being used as the actuation unit.

In a known way, the bottom rail 22 has a detent ledge 62 with periodically disposed detent windows 62 and, therein between, periodically arranged detent webs 64. They are formed in a base flange of the bottom rail 22; the reader is referred to FIG. 5 in particular. As shown in FIG. 9, this base flange is deformed upward in the region of the detent ledge in order to increase its inherent stability.

In a side flange 66 of the top rail 24 there are formed passageways 68 that are aligned with the passageways 54. The actuation ends 38 pass therethrough. As a result, the free ends of these actuation ends 38 are located outside of a channel-shaped cavity 70 defined by the two rails 22, 24. In the mounted condition, the module as shown in FIG. 10 is located within this cavity 70. The bearing shaft 40 is located within this cavity 70.

In the locked condition, two stopper teeth 36 usually respectively engage through an associated detent window 62 and abut each on a neighbouring detent web 64. In the unlocked condition, the stopper tooth 36 is located outside of the detent ledge but within the detent window 52.

The stopper springs 42 each abut on a border region of the stopper tooth 36 and on the upper flange 48 of the bearing part 44. This upper flange 48 of the bearing part has two fastening holes. These are aligned with holes in the side flange 66. The locking module is fastened through these holes, as can be seen in FIG. 10. Other fastening possibilities are not excluded. Thanks to the fixation, the lower flange 46 has space with respect to the detent ledge, as can be seen from several Figs. such as FIG. 5.

In the locked condition for which FIG. 3 shows a typical situation, various respective stopper parts 28-32 participate in the locking process. Accordingly, the locking position shown is only one of the possible positions. In the unlocked position as it is shown for example in FIG. 4, all the stopper parts 28-32 are pulled free, meaning they are in the unlocked position. This is achieved by the release part 60, which pushes a plate from the top onto the free ends of the actuation ends 38 (see FIG. 4).

Kinematic reversal is possible; instead of the bearing hole 34, there may be provided an axle journal or similar if the bearing shaft 40 is accordingly assembled from discrete pieces cooperating with the axle journals.

What is claimed is:

1. A pawl locking device of an adjustment device of a motor vehicle seat for adjusting two parts of said motor vehicle seat in one direction of adjustment comprising:
at least three stopper parts that are elastically biased independent of each other in a locking position by one stopper spring each and that each comprise one stopper tooth, one actuation end and one bearing hole; and
a bearing shaft that extends in the direction of adjustment and through the bearing hole of said stopper parts.

2. The pawl locking device as set forth in claim 1, wherein the actuation end and the stopper tooth integrally joined together.

3. The pawl locking device as set forth in claim 1, wherein the actuation end and the stopper tooth are rigidly joined together.

4. The pawl locking device as set forth in claim 1, wherein the stopper part is a flat sheet steel part or a punched sheet steel part.

5. The pawl locking device as set forth in claim 1, wherein the stopper parts each have one main plane and the main planes of the stopper parts are arranged in planes running parallel to each other.

6. The pawl locking device as set forth in claim 1, wherein the pawl locking device further comprises a bearing part having a bearing shaft, said bearing shaft is retained in said bearing part, said bearing part comprises shear windows, the number of the shear windows corresponds to the number of stopper parts, the stopper teeth have a cross section, the dimensions of the shear windows are adapted to said cross section of the stopper teeth and the stopper teeth are located in the shear windows.

7. The pawl locking device as set forth in claim 6, wherein the bearing part has an L-shaped profile.

8. A pawl locking device of a longitudinal adjustment device with a first rail and a second rail as set forth in claim 1, wherein a detent ledge is formed in the first rail, said detent ledge comprising periodically disposed detent windows and detent webs and cooperating with the stopper teeth, one passageway for each actuation end is provided in said second rail, said actuation end has a cross section, said passageway being of dimensions adapted to the cross section of the stopper teeth, and the actuation ends extend through the passageways.

9. The pawl locking device as set forth in claim 8, wherein the second rail is connected to at least one of the bearing part and the bearing shaft.

10. The pawl locking device as set forth in claim 8, wherein the first rail and the second rail define a channel-shaped cavity, and at least one of the bearing shaft and the bearing part are located in said channel-shaped cavity.

11. The pawl locking device as set forth in claim 6, wherein the stopper spring of each stopper part is interposed between the stopper part and the bearing part.

12. The pawl locking device as set forth in claim 1, wherein the adjustment device comprises a release part and said release part has a length adapted to the spacing between the actuation ends that are farthest from each other.

13. The pawl locking device as set forth in claim 1, wherein the adjustment device is a longitudinal adjustment device, which comprises at least one pair of rails with a bottom rail and an upper rail.
